(19) United States
(12) Patent Application Publication
(10) Pub. No.: US 2014/0125676 A1
(43) Pub. Date: May 8, 2014

(54) Feature Type Spectrum Technique

(71) Applicant: University of Massachusetts, Boston, MA (US)

(72) Inventor: Anthony McCaffrey, West Brookfield, MA (US)

(73) Assignee: University of Massachusetts, Boston, MA (US)

(21) Appl. No.: 14/059,578

(22) Filed: Oct. 22, 2013

Related U.S. Application Data
(60) Provisional application No. 61/716,681, filed on Oct. 22, 2012.

(51) Int. Cl. G06T 11/20

(52) U.S. Cl. CPC G06T 11/206
USPC 345/440.2; 345/440

(57) ABSTRACT

Objects in a sample set, and/or data representing those objects, are analyzed to determine whether the objects have features in a feature set. Each object may be analyzed more than once to produce multiple determinations of whether the object has features in the feature set. The frequencies with which features in the feature set are observed in the objects in the object set may be used to produce output representing the frequencies of observation. An example of such output is a bar chart representing the frequency of observation of features in the feature set in a particular object. The feature output may be used to identify one or more obscure (i.e., low frequency) features in the particular object. Various operations performed by the system may be performed by computers, humans, or a combination thereof.

### BACKGROUND

“Design fixation” is the tendency to fixate on the features of known solutions when trying to create novel solutions (Jansson & Smith, 1991). For example, a subject who is shown an existing chair and then asked to design an improved chair is likely to fixate on features of the existing chair when attempting to design an improved chair. Such fixation can lead the subject to overlook features that would be useful to include in an improved chair, but which are lacking in the existing chair.

### SUMMARY

Objects in a sample set, and/or data representing those objects, are analyzed to determine whether the objects have features in a feature set. Each object may be analyzed more than once to produce multiple determinations of whether the object has features in the feature set. The frequencies with which features in the feature set are observed in the objects in the object set may be used to produce output representing the frequencies of observation. An example of such output is a bar chart representing the frequency of observation of features in the feature set in a particular object. The feature output may be used to identify one or more obscure (i.e., low frequency) features in the particular object. Various operations performed by the system may be performed by computers, humans, or a combination thereof.

### BRIEF DESCRIPTION OF THE DRAWINGS

FIG. 1 is a bar chart representing an example of feature output according to one embodiment of the present invention;

FIG. 2 is an illustration of a part of a feature set, also referred to herein as a feature type taxonomy, according to one embodiment of the present invention;

FIG. 3 is an illustration of a plastic chair;

FIG. 4 is a dataflow diagram of a system for assisting in overcoming design fixation according to one embodiment of the present invention; and

FIG. 5 is a flowchart of a method performed by the system of FIG. 4 according to one embodiment of the present invention.

### DETAILED DESCRIPTION

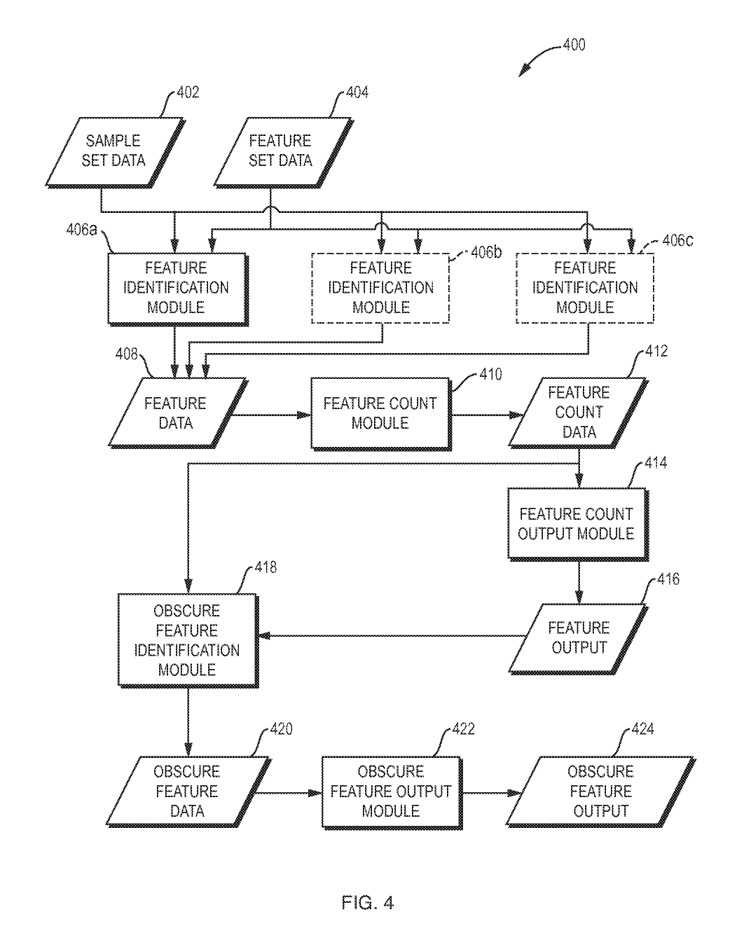

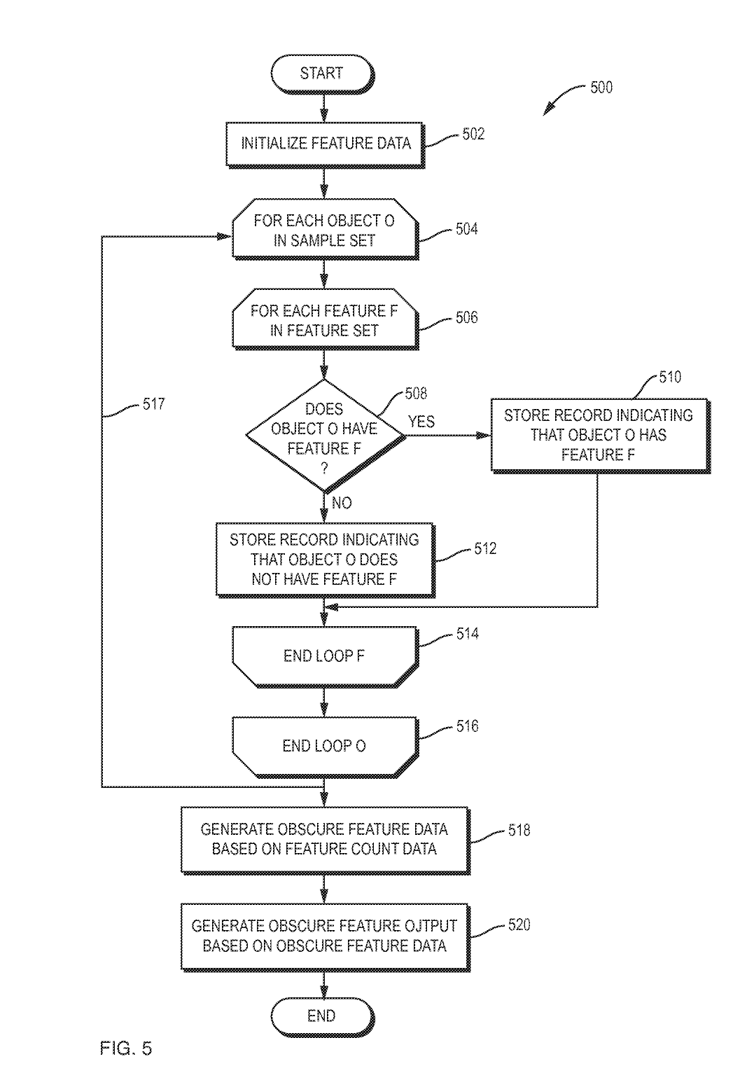

Embodiments of the present invention may be used to alleviate design fixation in a variety of ways. Referring to FIG. 4, a dataflow diagram is shown of a system 400 that may be used to alleviate design fixation according to one embodiment of the present invention. Referring to FIG. 5, a flowchart is shown of a method 500 performed by the system 400 of FIG. 4 according to one embodiment of the present invention.

Consider a set of objects in a particular class of objects, such as a set of chairs in the class of chairs. Such a set of objects in a particular class of objects will be referred to herein as a “sample set.” The system 400 of FIG. 4 includes sample set data 402 representing the sample set. The sample set data 402 may, for example, be computer-readable data representing the objects in the sample set. The sample set data 402 may be data stored in a non-transitory computer-readable medium. The sample set data 402 may, for example, be in the form of a database that includes one record for each of the objects in the sample set. Data representing an object in the sample set may take any form in the sample set data 402, such as a digital image of the object, a two-dimensional or three-dimensional model of the object, a textual description of the object, a parameterized model of the object (containing one or more parameters and corresponding parameter values), or any combination thereof. These are merely examples, however, and do not constitute limitations of the present invention. In general, the sample set data 402 may take any form consistent with the description herein.

The sample set may include any number of objects. For example, the sample set may consist of a single object. The sample set may, however, include two, three, or more objects, without any limit. As a result, the sample set data 402 may represent solely a single object, or two, three, or more objects, without any limit.

The objects in the sample set may have features that differ from each other. For example, one chair in the sample set may have four legs while another chair in the sample set may have three legs. As another example, one chair in the sample set may be constructed from plastic while another chair in the sample set may be constructed from wood.

Some objects in the sample set may have features that are lacking in other objects in the sample set. For example, one object in the sample set may be a rocking chair, which is capable of moving during its normal course of use, while another object in the sample set may be a conventional dining room chair, which is stationary during its normal course of use.

One function that may be performed by the system 400 of FIG. 4 and the method 500 of FIG. 5 is to identify features of the objects in the sample set. In particular, the system 400 may include a feature identification module 406a, which may identify features of the objects in the sample set 408 based on the sample set data 402, thereby producing feature data representing the identified features of the sample set.

Embodiments of the present invention may use a feature set, also referred to herein as a “feature type taxonomy.” The feature set may include any number of features, examples of which will be described below. The system 400 may include feature set data 404, which may represent the feature set. The feature set data 404 may, for example, be computer-readable data representing the features in the feature set. The feature set data 404 may be data stored in a non-transitory computer-readable medium. The feature set data 404 may, for example, be in the form of a database that includes one record for each of the features in the feature set. Data representing a feature in the feature set may take any form in the feature set data 404, such as a textual name of the feature, a definition of the feature, a human-readable description of the feature, or any combination thereof. These are merely examples, however, and do not constitute limitations of the present invention. In general, the feature set data 404 may take any form consistent with the description herein.

In the process described above, in which features of the objects in the sample set are identified, the system 400 may determine whether each object in the sample set has each of the features in the feature set. The system 400 may, for example, make such determinations based on the sample set data 402 and/or the feature set data 404. The result of such a determination for each feature-object pair may, for example, be a binary value (representing, e.g., “has” or “does not have”) for that feature-object pair. This set of binary values (one for each feature-object pair) may be contained within the feature data 408 that is output by the feature identification module 406a.

The feature identification module 406a may include: (1) one or more computers; (2) one or more humans; or (3) any combination of (1) and (2). For example, the feature identification module 406a may include a computer that automatically analyzes some or all of the sample set data 402 to produce some or all of the feature data 408 based on some or all of the feature set data 404. As another example, the feature identification module 406a may include a human who manually analyzes some or all of the sample set data 402 to produce some or all of the feature data 408 based on some or all of the feature set data 404.

The functions performed by the feature identification module 406a may be divided between computers and humans in any of a variety of ways. For example, a computer may produce feature data 408 for one object represented by the sample set data 402 automatically, while a human may produce feature data 408 for another object represented by the sample set data 402 manually. As another example, a computer may produce feature data for certain features of an object automatically, while a human may produce feature data for other features of the same object automatically, in which case the feature data 408 produced for that object will include some feature data produced by the computer and other feature data produced by the human.

If the feature identification module 406a includes a human, then the human may directly observe objects in the sample set using the human's senses, such as by looking at the object, touching the object, listening to the object, smelling the object, tasting the object, or any combination thereof. As this example illustrates, the sample set data 402 may include the objects in the sample set themselves, either in addition to or instead of data representing the objects in the sample set. Even if the feature identification module 406a includes a human, the human may produce some or all of the feature data 408 based on digital sample set data 402, such as digital images of the objects in the sample set, or on other indirect input containing information about the objects in the sample set, rather than based on direct sensory perception of those objects.

The system 400 may use the feature data 408 to produce feature output 416 representing the features of the sample set represented by the feature data 408. The feature output 416 may, for example, represent the frequency of occurrence of each feature in the feature data 408. For example, if one feature represented by the feature set data 404 is motion, then the feature output 416 may indicate the number of occurrences of the motion feature in the feature data 408. As will be described in more detail below, the feature output 416 may take any of a variety of forms, such as graphical output (e.g., a bar chart or other chart).

The feature data 408 may be used to generate the feature output 416 in any of a variety of ways. For example, the system 400 may include a feature count module 410. The feature count module 410 may generate, based on the feature data 408, for each feature in the feature set (represented by the feature set data 404), a count of the number of occurrences of the feature in the feature data 408. The count of the number of occurrences of a feature in the feature data 408 is referred to herein as the feature's “frequency count.” The frequency count for a particular feature may be obtained, for example, by summing the binary values corresponding to the particular feature in the feature data 408. The feature count module 410 may produce feature count data 412, which may include frequency counts for some or all of the features in the feature set (represented by feature set data 404) and for some or all of the objects in the sample set (represented by the sample set data 402).

The system 400 may include a feature count output module 414, which may produce feature output 416 based on the feature count data 412 in any of a variety of ways. For example, the feature count output module 414 may produce feature output 416 in the form of a chart, such as a bar chart, a pie chart, or other chart representing the frequency counts in the feature count data 412. Because such a chart may resemble a spectrum of values, such a chart, or its underlying data, may be referred to herein as a “feature type spectrum.” However, it should be appreciated that embodiments of the present invention are not limited to any particular representation of the feature count data 412 or to any particular visual depiction of the feature count data 412. Therefore, any reference herein to a “feature type spectrum” should be understood not to be limited to any particular examples disclosed herein, such as bar charts, but instead to encompass any kind of output representing the feature count data 412.

The techniques described above may be performed one or more times for each of some or all of the objects in the sample set. As one example, the system 400 may include one or more additional feature identification modules, such as feature identification modules 406b and 406c. Each of the feature identification modules 406a, 406b, and 406c may apply the techniques described above to the sample set data 402 and the feature set data 404. The frequency counts produced by the feature identification modules 406a-c may be aggregated (e.g., summed) with each other, so that the resulting feature data 408 represents the sums of the frequency counts produced by the feature identification modules 406a-c.

For example, consider the case in which the sample set consists of a single object, and in which the sample set data 402 therefore solely represents a single object. Now assume that the feature identification module 406a produces a frequency count of 1 for a particular feature of the sole object in the sample set, that feature identification module 406b produces a frequency count of 0 for the same feature of the sole object in the sample set, and that feature identification module 406c produces a frequency count of 1 for the same feature of the sole object in the sample set. In this case, the feature data 408 may include a value of two for the particular feature of the sole object in the sample set, as a result of summing 1, 1, and 0. The same technique may be applied to other features of the same object and to features of other objects (if the sample set contains other objects).

Although three feature identification modules 406a-c are shown in FIG. 4, this is merely an example and does not constitute a limitation of the present invention. The system 400 may include any number of feature identification modules, such as one, two, three or more feature identification modules. Each of the feature identification modules in the system 400 may be or include a computer, a human, or a combination thereof. For example, each of the three feature identification modules 406a-c may be a human. As another example, each of the three feature identification modules 406a-c may be a computer. As another example, one of the feature identification modules 406a-c may be a computer, while the other two of the feature identification modules 406a-c may be humans. These are merely examples and do not constitute limitations of the present invention.

The method 500 illustrated by FIG. 5 is an example of a method that may be used to implement the techniques disclosed above. The method 500 may, for example, be performed in whole or in part by one or more of the feature identification modules 406a-c. In particular, the method 500 begins by initializing the feature data 408 (FIG. 5, operation 502). The method 500 may, for example, initialize values corresponding to each of the features represented by the feature set data 404 to an initial value, such as zero.

The method 500 enters a loop over each object O in the sample set represented by the sample set data 402 (FIG. 5, operation 504). The method 500 enters a loop over each feature F in the feature set represented by the feature set data 404 (FIG. 5, operation 506).

The method 500 determines whether the object O has the feature F (FIG. 5, operation 508). The method 500 may make this determination in any of a variety of ways. In general, operation 508 may be performed by: (1) receiving the sample set data 402 and the feature set data 404 as input; (2) observing, analyzing, or otherwise processing some or all of the sample set data 402 and some or all of the feature set data 404 to determine whether the object O has the feature F. The determination may, for example, be made by one of the feature identification modules 406a-c. If the feature identification module that performs operation 508 is a computer, then the computer may make the determination using any of a variety of techniques. For example, if the sample set data 402 explicitly indicates, in a form that is automatically processable by the computer, that object O has feature F, then the computer may make the determination in operation 508 based directly on the sample set data 402. For example, the sample set data 402 may be pre-categorized by the creator of the sample set data 402. As a specific example, sample set data for a cup might indicate explicitly that the cup is made of ceramic and that ceramic is a type of material, where material is a type of feature. In this case, a computer may determine that the cup is made of ceramic based directly on the data in the sample set data, without any further processing.

If the feature identification module that performs operation 508 is a human, then the human may make the determination manually and provide input to the method using any suitable input device (such as a keyboard, mouse, microphone, touchscreen, or any combination thereof), wherein the input indicates whether the object O has the feature F. In this case, the system 400 and method 500 need not include the ability to determine whether object O has feature F automatically, but instead may rely on the judgment of the human, as represented by the input provided by the human to the system 400 and method 500. If the human input indicates that the object O has feature F, then the method 500 concludes in operation 508 that the object O has feature F. Conversely, if the human input indicates that the object O does not have feature F (or if the human input does not indicate that the object O has feature F), then the method 500 concludes in operation 508 that the object O does not have feature F.

Regardless of the manner in which the determination of operation 508 is made, if the object O is determined to have feature F, then the method 500 stores a record (e.g., in the feature data 408) indicating that object O has feature F (FIG. 5, operation 510); otherwise, the method 500 stores a record (e.g., in the feature data 408) indicating that object O does not have feature F (FIG. 5, operation 512).

Although operation 508 makes a binary determination of whether object O has feature F, resulting in a conclusion that object O either has or does not have feature F, this is merely an example and does not constitute a limitation of the present invention. More generally, any feature may have one or more parameters, each of which may have a set of permissible values. For example, assume that feature F has parameters P₀ and P₁, that parameter P₀ has a range of values V_{P0}(0) and V_{P0}(1), and that parameter P₁ has a range of values V_{P1}(0), V_{P1}(1), and V_{P1}(2). Considering two objects O₀ and O₁, both objects O₀ and O₁ may have feature F, and both objects O₀ and O₁ may have parameter P₀, but object O₀ may have a first value of parameter P₀ (such as value V₀(0)), while object O₁ may have a second value of parameter P₀ (such as value V_{P0}(1)). Objects may have any number of parameters of a feature, and an object that has a particular parameter of a feature may have any value of that parameter.

For example, the feature of color may have a parameter of hue, which may have a range of values such as red, blue, and green. For example, if feature F is the feature of color, then one pen may have an ink color of blue, while another pen may have an ink color of green. Both pens have the feature of color and the parameter of hue, but each pen has a different value of that parameter. As another example, three plastic cups may all have the feature of size and the parameter of magnitude, but the first plastic cup may have a parameter value of small, the second plastic cup may have a parameter value of medium, and the third plastic cup may have a parameter value of large.

An object may be said to “have” a parameterized feature if the object has any value of any parameter of that feature. For example, an object may be said to have the feature of “color” if the object has any value of the “hue” parameter of color (e.g., red, blue, or green). An object may be said not to “have” a parameterized feature if the object does not have any value of any parameter of that feature (or if the object has a null value for the parameterized feature). For example, if the only parameter of the “color” feature is “hue,” and a particular object does not have any “hue” value (or has a null “hue” value), then the particular object may be said to lack the feature of “color.”

Parameters and parameter values may be treated as features for any of the purposes described herein. For example, if the feature of “color” has parameters of “hue” and “intensity,” then the “hue” and “intensity” parameters may themselves be treated as features for any of the purposes described herein. For example, feature data 408, feature count data 412, feature output 416, and obscure feature data 420 may be generated for parameters and parameter values. As a particular example, an object with a “hue” parameter value of “green” may be said to have the “hue” feature and the “green” feature (i.e., the feature of “green-ness”).

Operation 508 may include correlating or mapping data, such as input provided by humans in the feature identification modules 406a-c, to features, parameters, and parameter values. For example, one human observer may provide input describing a feature of a stapler as “staples paper,” while another human observer may provide input describing a feature of the same stapler as “fastens paper together.” Operation 508 may include determining that both such statements refer to the same feature and that both statements indicate that the stapler has that feature.

The method 500 repeats the operations within the loop initiated in operation 504 (FIG. 5, operation 514), and repeats the operations within the loop initiated in operation 506 (FIG. 5, operation 516). Upon conclusion of operation 516, the feature data 408 includes frequency counts for all of the features of all of the objects in the sample set. It should be appreciated that, alternatively, the method 500 may produce frequency counts for fewer than all features in the feature set, for one or more objects in the sample set. Similarly, it should be appreciated that, alternatively, the method 500 may produce frequency counts for fewer than all objects in the sample set.

The method 500 may repeat one or more additional times (as illustrated by path 517 in FIG. 5). For example, the method 500 may be performed once by each of a plurality of feature identification modules in the system (e.g., feature identification modules 406a, 406b, and 406c). Note that the feature data 408 may be initialized only once (in operation 502), so that repeated performance of operations 504-516 causes frequency data produced by multiple feature identification modules to be combined (e.g., summed) with each other.

The system 400 also includes an obscure feature identification module 418, which may identify features of objects in the sample set having a particularly high frequency and/or features of objects in the sample set having a particularly low frequency, based on the feature count data 412 and/or the feature output 416, thereby generating obscure feature data 420, which indicates which features of the objects of the sample set have a particularly high frequency (i.e., features which satisfy a high frequency criterion) and/or which features of the objects in the sample set have a particularly low frequency (i.e., features which satisfy a low frequency criterion) (FIG. 5, operation 518).

The obscure feature identification module 418 may include: (1) one or more computers; (2) one or more humans; or (3) any combination of (1) and (2). For example, the obscure feature identification module 418 may include a computer that automatically analyzes some or all of the feature count data 402 to produce some or all of the obscure feature data 420 based on some or all of the feature count data 412. As another example, the obscure feature identification module 418 may include a human who manually analyzes some or all of the feature count data 412 to produce some or all of the obscure feature data 420 based on some or all of the feature count data 412.

Although not shown in FIG. 4, the system 400 may include multiple obscure feature identification modules, which may in combination produce the obscure feature data 420. Each of such multiple obscure feature identification modules may include: (1) one or more computers; (2) one or more humans; or (3) any combination of (1) and (2).

The obscure feature identification module 418 may produce the obscure feature data 420 in any of a variety of ways. For example, the obscure feature identification module 418 may determine, for each of one or more features in the feature set, whether the feature count data 412 indicates that the feature has a particularly low frequency (i.e., that the feature satisfies a low frequency criterion), such as by determining whether the frequency count for that feature is less than some predetermined maximum value (e.g., 3, 2, or 1). As a particular example, the obscure feature identification module 418 may determine whether the frequency count of the feature is equal to zero. As another example, the obscure feature identification module 418 may determine whether the frequency count of the feature is in the lowest X percentile of the frequency count data 412, where X may be any value, such as 1, 2, 5, 10, or 20. If the obscure feature identification module 418 determines that the frequency count for a feature is particularly low, then the obscure feature identification module 418 may store an indication, in the obscure feature data 420, that the feature has a particularly low frequency (i.e., is an obscure feature).

Additionally or alternatively, the obscure feature identification module 418 may determine, for each of one or more features in the feature set, whether the feature count data 412 indicates that the feature has a particularly high frequency (i.e., that the feature satisfies a high frequency criterion), such as by determining whether the frequency count for that feature is greater than some predetermined minimum value (e.g., 3, 2, or 1). As another example, the obscure feature identification module 418 may determine whether the frequency count of the feature is in the highest X percentile of the frequency count data 412, where X may be any value, such as 1, 2, 5, 10, or 20. If the obscure feature identification module 418 determines that the frequency count for a feature is particularly high, then the obscure feature identification module 418 may store an indication, in the obscure feature data 420, that the feature has a particularly high frequency, or that the feature does not have a particularly low frequency (i.e., is not an obscure feature).

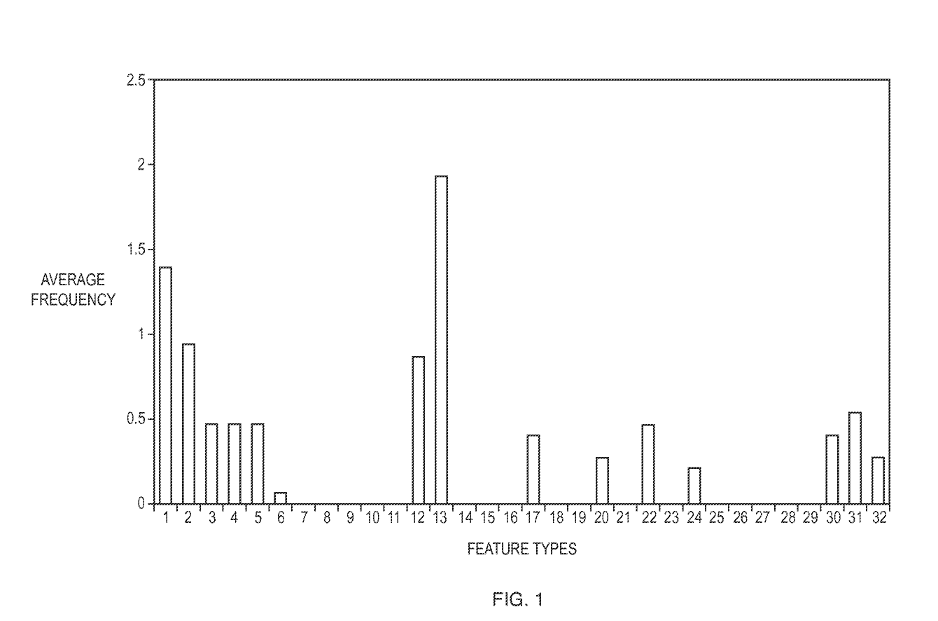

As one particular example, if the obscure feature identification module 418 includes one or more humans, then the human(s) may make the determination in operation 518 of FIG. 5 by manually viewing the feature output (e.g., the bar chart of FIG. 1) and manually determining whether certain features have particularly low frequencies (e.g., frequencies of zero).

The system 400 may include an obscure feature output module 422, which may produce obscure feature output 424 based on the obscure feature data 420 (FIG. 5, operation 520). In general, the obscure feature output 424 represents the obscure feature data 420. The obscure feature output module 422 may produce the obscure feature output 424 in any of a variety of ways. For example, the obscure feature output module 422 may produce the obscure feature output 424 in the form of a chart, such as a bar chart, a pie chart, or other chart representing the frequency counts in the obscure feature data 420.

The obscure features identified by the obscure feature data 420 may then be used to develop new instances of objects represented by the objects in the sample set, by developing new instances of objects having the obscure features represented by the obscure feature set 420. Such development may, for example, be performed manually by humans after observing output representing the obscure feature data 420, and then developing new instances of objects having features that are identified as obscure features by the obscure feature data 420. Embodiments of the present invention may assist in this process by, for example, automatically producing the obscure feature output 424 in a form which emphasizes the features identified as obscure features by the obscure feature data 420. For example, the obscure feature output 424 may be generated by modifying the feature output 416 (e.g., the bar chart of FIG. 1) to perform one or both of the following: (1) emphasizing (e.g., change the color of) features identified as obscure features by the obscure feature data 420, and (2) de-emphasizing (e.g., changing the color of, or removing the display of) features not identified as obscure features by the obscure feature data 420. The obscure feature output 424 may, for example, include output representing the obscure feature data 420 and not include output representing features not represented by the obscure feature data 420, so that the obscure feature output 424 presents to the user only representations of obscure features in the sample set and not other (non-obscure) features in the sample set. The system 400 may provide such modified output to users of the system 400 to make it easier for such users to quickly and easily understand which features in the feature set are infrequently or never observed in the objects in the sample set.

As described above, the feature identification modules 406a-c may include any combination of humans and computers. More generally, various aspects of the system 400 may be implemented using computers, humans, or a combination thereof. For example:
The sample set data 402 may, for example, be stored as data in a non-transitory computer-readable medium and in a format that is readable by a computer. Additionally or alternatively, for example, the sample set data 402 may be analyzable by humans without the aid of a computer. For example, the sample set may be or include the objects in the sample set themselves, or data representing the sample set in a format that may be analyzed by humans without the use of a computer, such as printed photographs of the objects in the sample set.
The feature set data 404 may, for example, be stored as data in a non-transitory computer-readable medium and in a format that is readable by a computer. Additionally or alternatively, for example, the feature set data 404 may be analyzable by humans without the aid of a computer. For example, the feature set data 404 may be implemented as a list of descriptions of features in the feature set, written on paper.
The feature data 408 may, for example, be stored as data in a non-transitory computer-readable medium and in a format that is readable by a computer. Additionally or alternatively, for example, the feature data 408 may be created and analyzable by humans partially or entirely without the aid of a computer. For example, the feature data 408 may be a description, written on paper or typed into a word processing document by human observers, of the presence/absence of features from the feature set in the objects in the sample set.
The feature count data 412 may, for example, be stored as data in a non-transitory computer-readable medium and in a format that is readable by a computer. Additionally or alternatively, for example, the feature count data 412 may be created and analyzable by humans partially or entirely without the aid of a computer. For example, the feature count data 412 may be a description, written on paper or typed into a word processing document by human observers, of the count of the number of observations of each feature from the feature set in the objects in the sample set. As described above, the count of observations of a particular feature for a particular object may be the sum of the number of observations of that feature in that object across all of the feature identification modules (some or all of which may be humans).
The obscure feature data 420 may, for example, be stored as data in a non-transitory computer-readable medium and in a format that is readable by a computer. Additionally or alternatively, for example, the obscure feature data 420 may be created and analyzable by humans partially or entirely without the aid of a computer. For example, the obscure feature data 420 may be a description, written on paper or typed into a word processing document by human observers, of features of objects in the sample set having particular high and/or particularly low frequencies of observation.
The obscure feature output 424 may, for example, be stored as data in a non-transitory computer-readable medium and in a format that is readable by a computer. Additionally or alternatively, for example, the obscure feature data 424 may be created and analyzable by humans partially or entirely without the aid of a computer.

The variations listed in the list above may be combined with each other in any combination.

As the description above makes clear, embodiments of the present invention may be used to alleviate design fixation in a variety of ways. In particular, the feature output 416 may provide a panoramic view of the possible types of features, and their relative observed frequencies, in more of more objects in a class of objects. Such a panoramic view enables innovators to see the obscure feature types available for new designs as well as the feature types that previous solutions have been built upon.

Similarly, the obscure feature output 424 may emphasize obscure features in the sample set to the user, thereby enabling the user to quickly and easily identify obscure features in the sample set. For example, if the obscure feature output 424 takes the form of a chart which emphasizes obscure features in the sample set, the user may quickly identify obscure features with a quick glance at the chart, even if there is a large number of samples in the sample set and a large number of features in the feature set.

Embodiments of the present invention may use any feature set containing any number and type of features in any combination. However, a particular example of a feature set, also referred to herein as a feature type taxonomy, will now be described. Furthermore, experiments that were conducted to develop the particular feature set will be described.

A collection of 1,001 historic inventions (Challoner, 2009) was examined. It was noted that the key obscure features needed for a solution all fell into one of 32 types of features. This set of 32 features, which is listed below, is one example of a “feature set” or “feature type taxonomy” as those terms are used herein.

To measure how many of the feature types are usually overlooked, we had fifteen subjects write down as many features and associations as they could in four minutes for each of a set of fourteen common objects (e.g., candle and broom). We classified their answers among the 32 feature types of our taxonomy. On average, subjects listed only one response or no responses for 20.7 of the 32 categories (64.7%). Nearly two-thirds of the feature types for these common objects were either completely overlooked (no responses) or underexplored (only one response). If innovative solutions are built upon obscure features, then this result implies that many new designs for these common objects have yet to be created.

To test this hypothesis, we worked with the results from a candle, created as many new designs as we could in two one-hour sessions, obtained audiences with two candle companies, and asked them to assess the novelty of our designs.

FIG. 1 shows our results for a candle in the form of feature type spectrum (FTS), named as such because it gives a kind of spectral analysis to the features of a candle (McCaffrey and Spector, 2011). The y-axis of FIG. 11 represents the average number of times these subjects listed a feature of a particular type. The x-axis shows the 32 feature types presented by number. The feature type spectrum shown in FIG. 1 is an example of the feature output 416 in the system 400 of FIG. 4. The frequencies illustrated by FIG. 1 are examples of the feature count data 412 in the system 400 of FIG. 4.

FIG. 1 shows a clear pattern of underexplored and ignored feature types that could become the basis for innovation. The low bars (representing low frequencies, e.g., low values in the feature count data 412) and non-existent bars (representing values of zero in the feature count data 412) of FIG. 1 point to the obscure feature types upon which to build new candle designs. Using FIG. 1, we were able to create ten new candle designs in two one-hour sessions.

For example, we designed a self-snuffing candle based on two overlooked features. No one mentioned anything about the motion (type #28) of a candle (e.g., candles are motionless when they burn) or weight (type #9: candles lose weight when they burn). Using weight loss to try to generate vertical motion, we proceeded to interact our weight-losing candle with other objects/materials commonly associated with vertical motion. Searching for objects commonly associated with vertical motion reveals a list, which includes a justice scale, elevator, helicopter, kite, rocket, trampoline, and catapult. Using the first object in the list as an example, we placed a candle on one side of a scale-like structure and counterbalanced it with a weight on the other side. We also put a snuffer at the top so the candle eventually moves into the snuffer as it loses weight and extinguishes itself.

Candles have existed for approximately 5,000 years. As a result, most people would conclude that the space of candle designs has nearly been exhausted. However, our results point to the opposite conclusion. If novel candle designs are built upon obscure features and people overlook approximately 18 of the 32 types of features (56%) of a candle (FIG. 1), then the space of new candle designs is possibly quite richly populated. Using the FTS method in which all steps were carried out manually by humans (i.e., in which none of the steps of the process was automated by a computer, other than the generation of a bar chart based on data entered manually by humans), novice candle designers were able to create nine novel designs in the space of two hours. The feature type spectrum technique allows innovators to focus on the overlooked feature types of an object, thus relieving design fixation which keeps innovators fixated on the feature types used in current designs.

The particular example of a feature type taxonomy disclosed herein is intended to be a taxonomy that generally applies to all physical objects and materials, in that it only contains types of features that can apply to all physical objects and materials. The particular feature type taxonomy disclosed herein, however, is merely an example and does not constitute a limitation of the present invention. In practice, it may be used as a default or starting point, or it may be entirely replaced by other taxonomies. Furthermore, although the particular example of a feature type taxonomy disclosed herein contains 32 categories of features, feature type taxonomies used in conjunction with embodiments of the present invention may contain any number of categories of features.

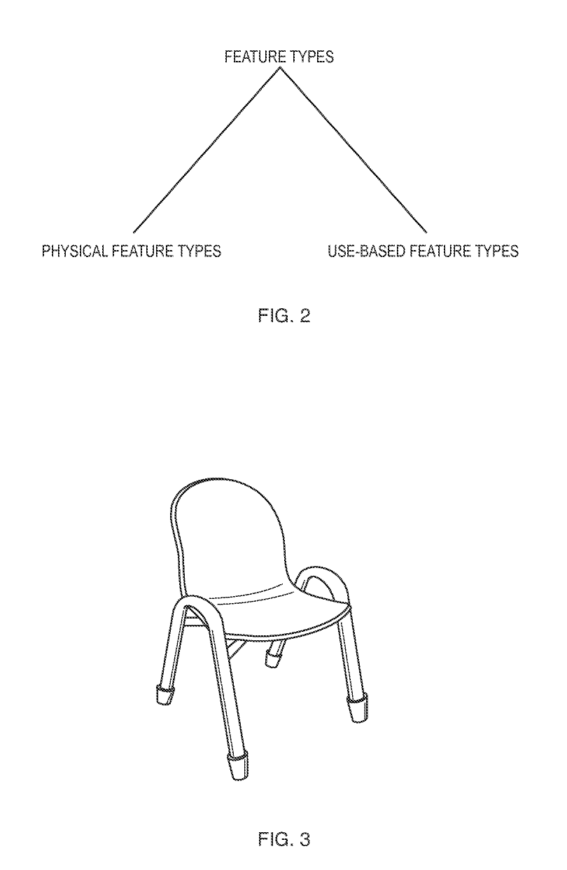

As shown in FIG. 2, the 32 feature types of the present example of a feature type taxonomy are segmented into two kinds: Physical Feature Types (14 feature types under this kind) and Use-Based Feature Types (18 features types under this kind). Before presenting all 32 feature types, the next section will first motivate the distinction between these two basic kinds.

We start with the distinction between features that are associated with a use and those that are not. Following Wittgenstein (1953), we will change the use of a common object and observe which types of features change their values and which types of features remain the same. The feature types that remain the same have a certain independence from the use of the object and will be considered physical features. The features that change as the object's use changes will be called use-based features.

Modernizing a thought experiment of Wittgenstein (1953), consider a PowerPoint presentation with several slides. On each slide is the same picture of a common plastic chair—and nothing else (FIG. 3).

A speaker shows the first slide and narrates, “Here is a picture of something to sit on.” The second slide is shown. “Here is a picture of something to stand on to change a light bulb.” The third slide is shown. “Here is a picture of a homeplate for a whiffle ball game.” The fourth slide is shown. “Here is a picture of something to leverage under a doorknob to prevent someone from entering a room.” The fifth slide is shown. “Here is something to row with.” Turn the chair upside down, grab two legs, and start paddling water with the back of the chair pressing against the water. The sixth slide is shown. “Here is something that can provide shade for a short delicate plant that cannot tolerate direct sunlight.” The seventh slide is shown. “Here is something for shovelling a pile of leaves.” Grab a chair handle with one hand and a chair leg with another hand, and then start to shovel the leaves. There are many other slides, but we will stop here.

Because the same object is shown on each slide, obviously some features remain the same. What features of the chair remain the same as the use changes? All the physical parts remain the same as well as the material, shape, size, color, texture, and aroma of each of the parts. Further, the mass, weight, state of matter (i.e., solid), and number (e.g., there are four legs) of the overall object and each of the parts remains the same. Finally, the pattern of connectivity among the parts remains the same (e.g., the legs are connected to the seat) as well as the spatial relations among the parts (e.g., the back is basically perpendicular to the seat). We will call the features that remain the same physical features.

What features change as the use changes? We will call these use-based features.

Table 1, below, presents the 32 types of features that are included in one example of a feature type taxonomy according to embodiments of the present invention. The first 14 feature types are considered the physical features that have a certain independence from the object's use. The remaining 18 feature types are considered the use-based features that take on their values while the object is in use and change when the object is used in a different manner.

The first column presents the name of the feature type. The second column gives a description of the feature type. The third column presents an example based on the common use of the plastic chair in FIG. 3.

TABLE 1
Example Feature Type Taxonomy

| | | Example (based on |
|---|---|---|
| | | plastic chair in |
| Name | Description | FIG. 3) |
| Parts | Identifiable | Legs |
| (First of the | components of | |
| Physical Features) | focal entity | |
| Material | Material make-up | Legs are metal |
| | of focal entity or | |
| | its parts | |
| Shape | Overall shape of | Legs are U-shaped |
| | focal entity or | cylinders |
| | its parts | |
| Symmetry | An important but | Legs are |
| | often overlooked | symmetrical in two |
| | characteristic of | dimensions |
| | the shape of a | |
| | focal entity | |
| Size | Length, width, | Legs are about 4 |
| | depth of focal | feet long and have |
| | entity or its | a diameter of 2 |
| | parts | inches |
| Color | . . . of focal entity | Legs are yellow |
| | or its parts | |
| Texture | . . . of focal entity | Legs are smooth |
| | or its parts | |
| Aroma | . . . of focal entity | No aroma for legs |
| | or its parts | |
| Number | Number of | 2 legs (because of |
| | components of a | the U-shape) |
| | certain kind of | |
| | the focal entity | |
| | of its parts | |
| Mass | . . . of focal entity | The mass of the |
| | or its parts | chair. |
| Weight | . . . of focal entity | A U-shaped leg |
| | or its parts | weighs about 1 |
| | | pound |
| State of Matter | (Solid, liquid, | Legs are solid |
| | gas, plasma) of | |
| | focal entity or | |
| | its parts | |
| Connectivity among | Physical | The legs are |
| Parts | connection among | connected to the |
| | components of the | seat |
| | focal entity. This | |
| | feature is based | |
| | on the chair when | |
| | it is not being | |
| | used. An inert | |
| | chair possesses | |
| | this feature of | |
| | its parts being | |
| | connected in some | |
| | way. | |
| Spatial Relations | Distance and | The bottoms of all |
| among Parts | direction of one | four legs form a |
| | component to | plane. |
| | another of the | |
| | focal entity. | |
| | Again, this | |
| | feature is based | |
| | on the chair when | |
| | it is not being | |
| | used. An inert | |
| | chair possesses | |
| | this feature of | |
| | their being | |
| | spatial relations | |
| | among the parts. | |
| External Relations | Relations of focal | The seat of the |
| (First of the Use- | entity to | chair relates to |
| Based Features) | environmental | the seat of a |
| | entities during a | person when the |
| | particular use of | chair is being sat |
| | the focal entity. | upon by the person |
| Environmental | Environmental | A chair is often |
| Partners | entities that the | used with a table |
| | focal entity is | or a desk. |
| | used with during a | |
| | particular use | |
| Motor Relations | How a human | To sit in a chair |
| | physically | requires a complex |
| | manipulates the | motor movement |
| | focal entity or | that involves |
| | its parts during a | bending the knees |
| | particular use | so that the seat |
| | | of the person |
| | | lands on the seat |
| | | of the chair. |
| Causal Relations | During a | When a person sits |
| | particular use, | on a chair, the |
| | the cause-effect | weight is fairly |
| | sequence set off | evenly distributed |
| | among the parts of | across the chair's |
| | the focal entity | seat. The weight |
| | as well as between | stresses the |
| | the focal entity | connecting points |
| | and its | between chair seat |
| | environmental | and the legs. |
| | entities | (etc.) |
| Place | The typical | Chairs often |
| | physical locations | appear in |
| | that the focal | kitchens, dining |
| | entity resides in | rooms, offices, on |
| | during a | decks, etc. |
| | particular use | |
| Occasion | The typical | Chairs are present |
| | contexts that a | during a family |
| | focal entity | meal or a cookout |
| | resides in during | on one's deck. |
| | a particular use | |
| Energy/Forces | During a | Because the chair |
| | particular use, | is plastic, static |
| | the types of | electricity often |
| | energy and forces | builds up between |
| | in play both | the chair surface |
| | within the focal | and the clothes of |
| | entity as well as | the person using |
| | within and among | the chair. |
| | the environmental | |
| | entities | |
| Perspective | The typical | A person of views |
| | physical viewing | the chair from a |
| | point that a human | vantage point of |
| | takes with respect | several feet above |
| | to the focal | the chair and |
| | entity during a | several to many |
| | particular use. | feet away from the |
| | | chair. The typical |
| | | perspective shapes |
| | | what parts of the |
| | | chair people tend |
| | | to notice and |
| | | which parts they |
| | | overlook. |
| Time | The typical time- | An occasion of |
| | frame | sitting commonly |
| | (milliseconds, | lasts between |
| | hours) that a | several minutes to |
| | focal entity | a couple of hours. |
| | occupies during a | |
| | particular use | |
| Motion | The typical type | A chair is |
| | of motion engaged | generally |
| | in by a focal | motionless when it |
| | entity during a | is being sat upon. |
| | particular use | |
| Permanence/Transience | How long the focal | A chair is usually |
| | entity tends to | designed to last |
| | last as it is used | for many years. |
| Superordinate | The more general | Based on its |
| | classification of | designed use, the |
| | the focal entity | superordinate of a |
| | based on its | chair is |
| | typical use | furniture. |
| Subordinate | More specific | Based on its |
| | versions of the | designed use, a |
| | focal entity based | subordinate of a |
| | on its typical use | chair is a rocking |
| | | chair or a bench. |
| Synonym (based on | Other entities | Other objects (not |
| use) | that can achieve | subordinates) that |
| | the same use as | can be sat on in a |
| | the focal entity | pinch. Examples: a |
| | | large flat rock, a |
| | | kitchen counter, a |
| | | coffee table. |
| Space | The spatial | Any spatial |
| | relations between | relation between a |
| | the focal entity | chair and other |
| | and the | objects during its |
| | environmental | designed use. |
| | entities during a | Example: a chair |
| | particular use | is pulled under a |
| | | table so that the |
| | | back of the chair |
| | | is about 1.5 feet |
| | | from the edge of |
| | | the table |
| Orientation | The spatial | In order to be sat |
| | orientation | upon, the chair is |
| | required for the | upright; that is, |
| | focal entity to | the seat of the |
| | achieve its use (a | chair is above the |
| | very important | legs. |
| | sub-case of | |
| | overall spatial | |
| | relations) | |
| Side Effects | Other effects | A side effect of |
| | besides the | sitting in a chair |
| | desired ones that | is the pressure of |
| | are produced while | the legs on the |
| | the focal entity | floor. If used in |
| | is in use | the same place on |
| | | the floor, over |
| | | time this pressure |
| | | can create |
| | | indentations on |
| | | the floor. |
| Sound | The sound emitted | A chair may creak |
| | by the focal | when a heavy |
| | entity during a | person sits on the |
| | particular use | chair. |

Although the feature type taxonomy shown in FIG. 2 is divided into two levels (types), this is merely an example and does not constitute a limitation of the present invention. More generally, feature type taxonomies used in conjunction with embodiments of the present invention may take any form. For example, a feature type taxonomy may have a hierarchical (e.g., tree-shaped) form with any number of levels, branches, and nodes in any configuration.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

The description herein refers to objects “having” features. In practice, embodiments of the present invention may determine whether a particular object has a particular feature based on the feature data 408 that is output by the feature identification modules 406a-c. In practice, the feature data 408 may include records of observations, memories, judgments, and other determinations (by computers and/or humans) of whether particular objects have particular features. Embodiments of the present invention may use such records of determinations as proxies for the actual features of the actual objects themselves. Therefore, any reference herein to an object “having” a feature, parameter, or parameter value should be understood to refer to an indication (e.g., by the feature data 408) that the object has the feature, parameter, or parameter value (such as an indication resulting from a perception or conclusion by one or more of the feature identification modules 406a-c that the object has the feature, parameter, or parameter value), whether or not the object actually has the feature, parameter, or parameter value.

Therefore, references herein to the “frequency” or “frequency of occurrence” of a feature, parameter, or parameter value with respect to a particular object should be understood to refer to the frequency with which the feature, parameter, or parameter value is indicated by the feature data 408 with respect to the particular object (e.g., the number of times the feature identification modules 406a-c determine that the object has the feature, parameter, or parameter value). Certain observations of a particular object may result in a determination that the object has a particular feature, parameter, or parameter value, while other observations of the same object may not result in a determination that the object has the particular feature, parameter, or parameter value. For example, a ceramic cup may be observed by three different people, two of whom may conclude that the cup has the material parameter value of “ceramic,” and one of whom may not conclude that the cup has the material parameter value of “ceramic.”

Similarly, features described herein as “use-based features” are statements about how an object may be used (e.g., the place of use or the occasion of use). For example, a ceramic cup often appears in restaurants, diners, and kitchens. These are examples of the ceramic cup's place of use. Examples of occasions of use for a ceramic cup may include: drinking a hot liquid with a meal and drinking coffee with breakfast. In these examples, the object (i.e., ceramic cup) does not inherently “have” the stated feature. Instead, the stated feature (e.g., the ceramic cup's place of use or occasion of use) describes circumstances commonly associated with the use of the object. Therefore, references herein to an object “having” a particular use-based feature, parameter, or parameter value refers to the fact that the object was observed or otherwise determined to have the particular use-based feature during the object's normal course of use.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

What is claimed is:

1. A method performed by at least one computer processor executing computer program instructions stored on a non-transitory computer-readable medium, the method comprising:
(A) generating, for each feature F in a plurality of features, a plurality of frequencies of observation of feature F in an object O; and
(B) generating output representing the plurality of frequencies of observation of feature F in object O.

2. The method of claim 1, wherein (A) comprises:
(A) (1) generating, for each feature F in the plurality of features, a first indication of whether object O was observed to have feature F, thereby generating a first plurality of indications for object O;
(A) (2) generating, for each feature F in the plurality of features, a second indication of whether object O was observed to have feature F; thereby generating a second plurality of indications for object O; and
(A) (3) generating the plurality of frequencies of observation of feature F in object O based on the first and second pluralities of indications for object O.

3. The method of claim 1, wherein the output representing the plurality of frequencies of observation of feature F in object O comprises a chart representing the plurality of frequencies of observation of feature F in object O.

4. The method of claim 3, wherein the chart comprises a bar chart.

5. The method of claim 3, wherein the chart comprises a pie chart.

6. The method of claim 1, further comprising:
(C) identifying, based on the plurality of frequencies of observation of feature F in object O, a first subset of the plurality of features having frequencies satisfying a low frequency criterion.

7. The method of claim 6, wherein the low frequency criterion comprises a maximum value, and wherein the first subset comprises features in the plurality of features having frequencies less than the maximum value.

8. The method of claim 6, further comprising:
(D) identifying, based on the plurality of frequencies of observation of feature F in object O, a second subset of the plurality of features having frequencies satisfying a high frequency criterion.

9. The method of claim 8, wherein the high frequency criterion comprises a minimum value, and wherein the second subset comprises features in the plurality of features having frequencies greater than the minimum value.

10. The method of claim 6, further comprising:
(D) generating output representing the first subset of the plurality of features having frequencies satisfying the low frequency criterion.

11. The method of claim 10, wherein the output representing the first subset of the plurality of features having frequencies satisfying the low frequency criterion includes output representing the frequencies satisfying the low frequency criterion.

12. The method of claim 10, where the output representing the first subset of the plurality of features having frequencies satisfying the low frequency criterion comprises a chart.

13. The method of claim 12, wherein the chart comprises a bar chart.

14. The method of claim 12, wherein the chart comprises a pie chart.

15. The method of claim 10, wherein the output representing the plurality of frequencies of observation of feature F in object O includes the output representing the first subset of the plurality of features having frequencies satisfying the low frequency criterion.

16. The method of claim 15, wherein the output representing the first subset of the plurality of features having frequencies satisfying the low frequency criterion comprises output emphasizing the first subset of the plurality of features.

17. A non-transitory computer-readable medium comprising computer program instructions executable by at least one computer processor to perform a method, the method comprising:
(A) generating, for each feature F in a plurality of features, a plurality of frequencies of observation of feature F in an object O; and
(B) generating output representing the plurality of frequencies of observation of feature F in object O.

18. The non-transitory computer-readable medium of claim 17, wherein the output representing the plurality of frequencies of observation of feature F in object O comprises a chart representing the plurality of frequencies of observation of feature F in object O.

19. The non-transitory computer-readable medium of claim 18, wherein the chart comprises a bar chart.

20. The non-transitory computer-readable medium of claim 17, wherein the method further comprises:
(C) identifying, based on the plurality of frequencies of observation of feature F in object O, a first subset of the plurality of features having frequencies satisfying a low frequency criterion.

21. The non-transitory computer-readable medium of claim 20, wherein the low frequency criterion comprises a maximum value, and wherein the first subset comprises features in the plurality of features having frequencies less than the maximum value.

22. The non-transitory computer-readable medium of claim 20, wherein the method further comprises:
(D) identifying, based on the plurality of frequencies of observation of feature F in object O, a second subset of the plurality of features having frequencies satisfying a high frequency criterion.

23. The non-transitory computer-readable medium of claim 22, wherein the high frequency criterion comprises a minimum value, and wherein the second subset comprises features in the plurality of features having frequencies greater than the minimum value.

24. The non-transitory computer-readable medium of claim 6, wherein the method further comprises:
(D) generating output representing the first subset of the plurality of features having frequencies satisfying the low frequency criterion.

25. The non-transitory computer-readable medium of claim 24, wherein the output representing the first subset of the plurality of features having frequencies satisfying the low frequency criterion includes output representing the frequencies satisfying the low frequency criterion.

26. The non-transitory computer-readable medium of claim 24, wherein the output representing the plurality of frequencies of observation of feature F in object O includes the output representing the first subset of the plurality of features having frequencies satisfying the low frequency criterion.

27. The non-transitory computer-readable medium of claim 26, wherein the output representing the first subset of the plurality of features having frequencies satisfying the low frequency criterion comprises output emphasizing the first subset of the plurality of features.

28. A method performed by at least one computer processor executing computer program instructions stored on a non-transitory computer-readable medium, the method comprising:
(A) generating, for each feature F in a plurality of features, a plurality of frequencies of observation of feature F in an object O;
(B) identifying, based on the plurality of frequencies of observation of feature F in object O, a first subset of the plurality of features having frequencies satisfying a low frequency criterion;
(C) generating output representing the first subset of the plurality of features having frequencies satisfying the low frequency criterion.

29. The method of claim 28, wherein the output representing the first subset of the plurality of features having frequencies satisfying the low frequency criterion includes output representing the frequencies satisfying the low frequency criterion.

30. The method of claim 28, where the output representing the first subset of the plurality of features having frequencies satisfying the low frequency criterion comprises a chart.

31. The method of claim 30, wherein the chart comprises a bar chart.

32. A non-transitory computer-readable medium comprising computer program instructions executable by at least one computer processor to perform a method, the method comprising:
(A) generating, for each feature F in a plurality of features, a plurality of frequencies of observation of feature F in an object O;
(B) identifying, based on the plurality of frequencies of observation of feature F in object O, a first subset of the plurality of features having frequencies satisfying a low frequency criterion;
(C) generating output representing the first subset of the plurality of features having frequencies satisfying the low frequency criterion.

33. The non-transitory computer-readable medium of claim 32, wherein the output representing the first subset of the plurality of features having frequencies satisfying the low frequency criterion includes output representing the frequencies satisfying the low frequency criterion.

34. The non-transitory computer-readable medium of claim 32, where the output representing the first subset of the plurality of features having frequencies satisfying the low frequency criterion comprises a chart.

35. The non-transitory computer-readable medium of claim 34, wherein the chart comprises a bar chart.
